(19) United States
(12) Patent Application Publication
(10) Pub. No.: US 2013/0181688 A1
(43) Pub. Date: Jul. 18, 2013

(54) SYSTEM AND METHOD FOR VARIABLE SPEED GENERATION OF CONTROLLED HIGH-VOLTAGE DC POWER

(71) Applicants: Christopher N. Tupper, Harpswell, ME (US); Duncan G. Wood, Harpswell, ME (US)

(72) Inventors: Christopher N. Tupper, Harpswell, ME (US); Duncan G. Wood, Harpswell, ME (US)

(73) Assignee: RAVEN ENERGY ALTERNATIVES, LLC, Brunswick, ME (US)

(21) Appl. No.: 13/877,308

(22) PCT Filed: Oct. 6, 2011
(86) PCT No.: PCT/US11/55015

§ 371 Date: Apr. 1, 2013

Related U.S. Application Data
(60) Provisional application No. 61/390,382, filed on Oct. 6, 2010.

(51) Int. Cl. H02P 9/36

(52) U.S. Cl. CPC H02P 9/36
USPC 322/61

(57) ABSTRACT

A system and method are disclosed for advantageously using field-controlled high-frequency alternators for the generation of controlled high-voltage DC power from variable speed mechanical power sources such as wind turbines, water wheels, and gas or steam turbines. The production of controlled high-voltage DC power without involving hard switching of the full output power is described.

### BACKGROUND OF THE INVENTION

1. Field of Invention

The invention relates generally to the use of field-controlled high-frequency alternators for generating electrical power, and more specifically to generating controlled output power from the variable speed operation of a mechanical power source such as a wind turbine or similar power source, and its interconnection with high voltage DC distribution lines.

2. Description of the Prior Art

There is a need for improved methods of generating electricity from variable speed sources such as wind power, hydro power, and from waste heat recovery systems employing steam cycle machines or gas turbines or similar equipment. Taking wind power as an example, there are various methods for converting wind power to electrical power. There are systems that utilize power generators which operate directly in synchrony with the grid power frequency, such systems including synchronous generators, which require constant speed shafts, and other systems, such as doubly fed induction or wound rotor induction machines, wherein the speed of the shaft can be allowed to vary from synchronous speed by making compensating modifications to the magnetic field of the rotor. Other types of variable speed generator systems can also be used, such as the Brushless High Frequency Alternator and Excitation Method for Three Phase AC Power Frequency Generation disclosed by Tupper, et. al., in U.S. Pat. No. 7,615,904. The variable speed generators allow the aerodynamic portions of the wind turbine system to operate most efficiently as the wind speed varies. “High-frequency,” as used herein, is not a precise term but refers to variable frequencies generally higher than the normal power frequencies of 50-60 Hz.

Recently, variable speed generators, including permanent magnet generators have been allowed to produce “wild AC” from the variable speed operation of the turbine; although the frequency of this “wild AC” varies with the shaft speed, this becomes unimportant as the power is rectified into DC electrical power and supplied, via a DC link, to an inverter, which in turn is connected to the grid and converts the DC power back to AC power in synchrony with the grid power frequency. The AC power is easily transformed to high voltages for long distance transmission. High voltage transmission reduces the currents involved in the power transmission, and many losses are greatly reduced as the current levels are reduced.

In permanent magnet machines, the output voltage of the wild AC also varies with the generator speed, which is linked to the turbine shaft speed and thus varies with wind speed. This voltage variation complicates the job of managing the DC link. Multiple permanent magnet generators operating at different speed and power levels generate multiple levels of output voltage which need to be converted in order to be connected to a common DC bus. To convert these wild AC voltages and power to grid or inverter voltages requires “hard switching” of the full output power of the turbine. By contrast, controlled AC or DC voltage output can be achieved without hard switching of the full output power by the use of field-modulated high-frequency alternators as disclosed by Tupper, et. al., in pending U.S. patent application Ser. No. 12/614,157, filed Nov. 6, 2009, entitled “Brushless High Frequency Alternator and Excitation Method for DC, Single-Phase and Multi-Phase AC Power Frequency Generation.” The content of that application is incorporated herein by reference. In that system, voltage control is achieved by modulation of a low-power field excitation circuit.

For offshore power generation, the usual advantages of high voltage AC power transmission are offset by the parasitic losses associated with capacitive coupling of the cable's AC electric and magnetic fields to the sea water through which the cable must pass. In this case DC power transmission may be more effective. Once ashore, the DC power can be converted to grid-synchronous AC power, typically through the use of inverters. As noted in the above descriptions of variable speed systems, DC power can, and often is achieved by rectification of the “wild AC” output of the various generators. However, for various reasons the practical voltages achieved within the generators are significantly lower than the voltages needed for high-voltage DC transmission. Furthermore, transforming DC power from low-voltage DC to high-voltage DC requires “hard switching” of the full output power, which requires expensive electronics and their associated efficiency losses and reliability issues. The reliability of the electronic switching circuits is challenged by the hard switching process.

Recently, high-voltage DC has also been used for long distance transmission ashore. In shore side installations for high-voltage DC transmission, three-phase grid AC is stepped up to high-voltage and rectified into DC. Because the grid power frequency is so low in this case, (50 or 60 Hz) the so called rectification ripple is significant; this rectification ripple is sometimes mitigated by using a combination of Wye and Delta transformers on the AC side and utilizing twelve rectifier valves (diodes, SCRs, etc) for twelve pulse rectification instead of the typical six valves used for hex-phase rectification to produce the DC. This approach reduces the ripple content in the resultant DC power.

### SUMMARY OF THE INVENTION

It is an object of the invention to provide a system and method for generating high-voltage electrical power suitable for long distance transmission from the variable speed operation of a wind turbine or other variable speed mechanical power source. It is also an object of this invention to produce controlled output voltage (or output current) without the need for “hard switching” of the full output power of the generator. More specifically, it is an object of this invention to generate controlled amounts of high-voltage DC power from a variable speed wind turbine without the need for “hard switching” of the full output power. It is a further objective to offer the possibility to simplify weight and complexity of transformers needed to accomplish the high-voltage DC. It is a further object to allow multiple turbines or other similar sources, each operating at its own speed and power level, to be electrically connected to a common DC bus, dramatically simplifying overall system electronics.

The objects set forth above as well as further and other objectives and advantages of the present invention are achieved by the embodiments of the invention as described below.

High-voltage DC Electrical power is generated in a multi-step process from the mechanical rotation of a shaft which in turn is powered by a wind turbine or other variable speed mechanical power source such as a water wheel or gas turbine. A field-controlled high-frequency alternator is used to create multiple phase high-frequency AC power from the rotation of the shaft; the level of excitation current in the alternator's field coils is used to establish the strength of the magnetic fields within the alternator, and the rotation of the shaft moves the magnetic fields past multiple phases of armature coils, thus producing alternating voltage “AC” within the various armature phases. The magnitude of this alternating voltage is proportional to the product of the field strength and the pole frequency. The target output voltage level for this generation is selected on the basis of practical generator design, and is typically significantly less than the voltage required for high-voltage AC or high-voltage DC power transmission. The high-frequency AC will be produced at a frequency related to the pole frequency, which is uncontrolled and is proportional to the product of the pole count and (variable) shaft speed. A feedback system controls the field current to achieve the desired magnitude of output voltage or power, while the frequency is left uncontrolled. The controlled-voltage high-frequency AC phases are then converted to high-voltage AC by use of transformers suitable for high frequency power. The high-voltage AC output from the transformer is controlled because the voltage from the generator is controlled; meanwhile the high-voltage AC frequency is still at the uncontrolled pole frequency. The multiple phases of high-voltage AC are then transmitted to a rectifier, which, for reasons to be discussed later, may be chosen to be close at hand or some distance away. The high-voltage nature of this AC power reduces the current levels to be handled and assists in low loss transmission. The multiple phases of high-voltage AC are then rectified by the rectifier into high-voltage DC power, the voltage of which is controlled because the generator phase voltages are controlled. The rectifier can use the “natural commutation” of the typical diode rectifier bridge to achieve the conversion to DC without involving “hard switching” of the output power. The uncontrolled high-frequency AC essentially disappears in the rectification process, and, if suitable pole frequencies are selected in the generator design, the rectification ripple may be well above frequencies of concern and easily filtered. This high-voltage DC power may be at voltages suitable for common connection to a DC bus for long distance transmission or at voltages suitable for use in the DC bus of an inverter. Therefore, through use of the field-controlled high frequency alternator, controlled amounts of high-voltage DC power can be generated from the rotation of a wind turbine shaft without the need for “hard switching” of the full output power, accomplishing a major objective of this invention.

Additional advantages of the present invention will become apparent upon review of the following detail description, accompanying drawings and the appended claims.

### BRIEF DESCRIPTION OF THE DRAWINGS

FIG. 1 shows a schematic arrangement of the mechanical and electrical components and flow of mechanical and electrical power and signals for the preferred embodiment of the present invention.

FIG. 2 shows an alternate embodiment with two secondaries connected in series for reduced output ripple and reduced voltage rating requirements.

### DETAILED DESCRIPTION OF THE INVENTION

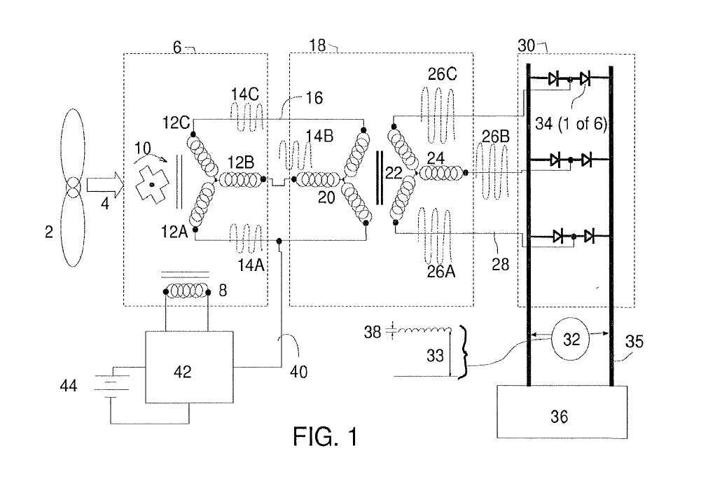

Referring to FIG. 1, a system and method for variable speed generation of controlled high-voltage DC power may be understood by examining the schematic arrangement of flow of mechanical and electrical power and signals for the preferred embodiment. A source of variable speed mechanical power 2, which may be a wind turbine, water wheel, steam turbine, or gas turbine or other such device, provides power to turn, at variable speeds, a shaft 4 connected to a high-frequency alternator 6, which includes one or more field coil(s) 8, which can be energized by field coil electrical currents to produce magnetic fields magnetically coupled to magnetic structure 10 that moves with the shaft rotation. This motion of magnetic structure 10 causes variation of the magnetic intensity within multiple phases of magnetically coupled output windings, typically three stationary armature windings as shown here by 12A, 12B, 12C, which are magnetically coupled to magnetic structure 10; this variation of the magnetic field produces high-frequency alternating current “AC” output phase voltages 14A, 14B, 14C. The generator is designed so that these output phase voltages are typically phase displaced by ⅓ electrical cycle (120 degrees) to facilitate power transfer, transformation, and later rectification this is a high frequency version of, so called, three-phase operation but, in general, the technique is not limited to three-phase applications. The magnitude of these high-frequency voltages is proportional to shaft speed and to the strength of the magnetic field, which is proportional to the field current in the field coil(s) 8. The frequency of these high-frequency AC voltages is proportional to the pole frequency which in turn is proportional to the number of poles and the (variable) shaft speed. The high-frequency generator may be designed for pole frequencies of 400-1200 Hz, or higher, and this reduces the required size of the generator for a given voltage and power level as compared to generators designed for power-frequency (50 or 60 Hz) generation. A particular example of a suitable high-frequency alternator is disclosed by Tupper, et. al., in pending U.S. patent application Ser. No. 12/614,157 incorporated herein by reference. This particular example has the further advantage of being a brushless alternator, making it more reliable than typical high frequency alternators wherein the field coils are located on the rotor and wherein field coil currents enter and leave the rotor by means of brushes, which are generally subject to significant troublesome wear.

In the present invention, the output phase voltages 14A, 14B, 14C are connected by cable 16 to transformer 18, here shown as primary windings 20, which are magnetically coupled by magnetic component 22 to high voltage secondary windings 24. The transformer 18 is used to step up the voltage from the levels practical for generator design, typically hundreds of volts, to the high-voltage levels practical for long distance power transmission, typically tens of thousands or hundreds of thousands of volts, with the ratio of input voltage to output voltage being determined by the ratio of turns between the primary and secondary windings.

The transformer 18 may be separate transformers for each phase or a multiphase transformer. The transformer 18 may be connected in wye configuration (as shown) or in delta configuration, or may include multiple transformer connections in order to create individual phases for later pulse rectification in a manner understood in the art. The transformer 18 can be designed for appropriate high-frequency transformer operation based on the pole frequency. The transformer 18 is designed to accommodate a range of operating frequencies proportional to the range of shaft speeds to be expected. Attention must be paid to core losses such as magnetic hysteresis and eddy currents; these losses are known to increase with increasing operating frequency. Low core-loss construction, such as the use of thin laminates, and/or the use of other low core-loss materials can assist in reducing losses in high-frequency transformers. As the frequencies are increased, the size of the transformer can be reduced, saving weight. Military and aircraft systems often employ 400 Hz (synchronous) AC generator systems and gain important transformer weight savings and space savings. This is one advantage of using high-frequency generation as opposed to power-frequency (50-60 Hz) generation.

High voltage secondaries 24 have high voltage outputs 26A, 26B, 26C, the amplitude of which is controlled because the amplitude of the voltages 14A, 14B, 14C are controlled. High voltage outputs 26A, 26B, 26C are still at the pole frequency, which is related to the (variable) shaft speed. These output voltages are connected by cable 28 to rectifier 30, here shown as a hex bridge rectifier utilizing six valve elements 34 (which may be diodes, SCRs or IGBT devices). Rectifier 30 may also be a twelve valve rectifier for twelve pulse rectification in order to reduce rectification ripple, as explained earlier. Because of the high voltages, the currents in cable 28 are reduced, which helps reduce conduction losses and also reduces rectification losses. This makes it practical to transmit the power some relatively large distance from the transformer 18 to the rectifier 30, if so desired. This would be useful in a wind park for an intermediate collection system before final transformation to utility connection voltages.

The rectifier 30 may be a passive rectifier built with diodes as valve elements 34 and employing natural commutation in the conversion of power from high-voltage AC to high-voltage rectified output power 32, which is essentially DC electrical power, this is accomplished without any hard switching of the output power. This achieves a major objective of the present invention. Alternately, the rectifier 30 might be an active rectifier employing SCR or IGBT devices as valve elements 34 and employing hard switching. The use of active rectifier schemes has been shown to reduce the size of the generator needed by reducing the “power factor” of the high-frequency phase currents. With this invention, the system designer retains the flexibility to use either approach while maintaining the advantages of voltage control.

Rectified output power 32 consists primarily of DC component 33 and a smaller high frequency rectification ripple component 38. In the system shown the rectification ripple 38 in the rectified output power 32 of the rectifier 30 will be at six times the pole frequency; by selecting appropriate pole frequency (ranges) the system can be designed such that the ripple frequencies are significantly higher than frequencies of interest in output power. Also, the higher the ripple frequency, the easier it is to filter out of the output. If any passive components (not shown) are to be employed to remove the ripple frequency the required physical sizes of such components are reduced as the ripple frequency is increased. This is another advantage of employing high-frequency generation. Rectified (DC) output power 32 is then ready for connection by cable 35 to load 36 which might be a high-voltage DC transmission cable or a DC bus for an inverter system.

The voltage of DC output 32 will be controlled because the amplitudes of voltages 14A, 14B and 14C are controlled. This is accomplished by feedback sensor 40, which may be a simple conductor to controller 42, which modulates the currents in field coil(s) 8 to achieve the desired voltage. Controller 42 requires a power source 44, which might be a battery or a grid connection, to drive the currents in field coil(s) 8 as well as power for its internal control operations. The controller 42 may be provided with some reference indicating the desired level of electrical output. Various arrangements are possible for providing such reference. Feedback sensor 40 is shown as measuring output voltages 14A, etc., but could be equally well be used to measure outputs further downstream such as voltages 26A, etc., or the voltage DC power output 32. The further downstream feedback sensor 40 measures, the better the output control, but the more complicated the sense cabling and voltage scaling becomes.

The objectives, operation and advantages of this invention have been described in terms of voltage control and such systems are most easily comprehended by such an approach. Alternatively, however, current control is sometimes more useful and is as easily achieved with the present invention. If the load 36 is a grid-link or bus connection fed by multiple sources, then it is unlikely that a single wind turbine system, such as described by this invention, will be of sufficient power to control the grid system voltage, and the grid system itself fixes the voltage and thus the effective voltages at all the various stages previously described under voltage control. In this case, a primary control objective is to control the power flow from the turbine to the grid, in order to maximize the power extraction without stalling the turbine or overloading the generator components. The control of power flow is most easily accomplished by controlling the current flow in cable 16, the current flow in high voltage AC cable 28 or the current flow in DC output power 32. A second embodiment of this invention follows closely upon the first, with a change being that the feedback sensor 40 would be a current sensor connected to controller 42 by signal cables. In this embodiment, controller 42 needs, as its reference, to know the power available from the turbine (which would depend upon the wind and turbine speeds) and must compare that to power equivalent of the current flow measured in feedback sensor 40. The controller then adjusts the field currents in field coil(s) 8 accordingly. Using this approach, the output from multiple turbines or similar devices operating at multiple speeds and power points may be combined into a common grid.

Another advantage of the present invention is apparent in an alternate embodiment in which transformer 18 may be a multi-tap transformer with switch gear to change the transformer turns ratio. An advantage of the present invention is the ability to control the generator output voltage and thus the rectified high voltage DC power across a varying range of turbine speeds through adjustment of the field coil currents. At slow speeds, the field coil currents must be increased to increase the magnetic intensity in the generator in order to maintain the desired output voltage. It will be understood that at some point this will reach a practical limit as the magnetic circuit reaches saturation. This saturation establishes the low speed limit for the system, below which the required magnetic field cannot be increased enough to produce sufficient voltage to match the grid. Typically, in wind turbines and waterwheels, there is limited mechanical power available during low speed operations (for example, in low wind speeds), but it is often desired to make sufficient voltage even at low speeds, in order to contribute to the grid whatever power is available. By adjusting the transformer ratio of transformer 18 upwards during low speed operations, the generator output voltage required to make grid voltage is reduced; this in turn allows the field currents to be reduced so that the magnetic field falls below saturation levels. This means the “dynamic range” of variable speeds of the system can be extended significantly downward, increasing its usefulness in extracting energy from the variable energy flows of wind or water or waste heat. At lower generator voltage levels (for a given power level), the current levels required from the generator will increase. But, since the power levels at low speed are generally low, by proper design the resultant current levels can be arranged to match those for which the generator is designed.

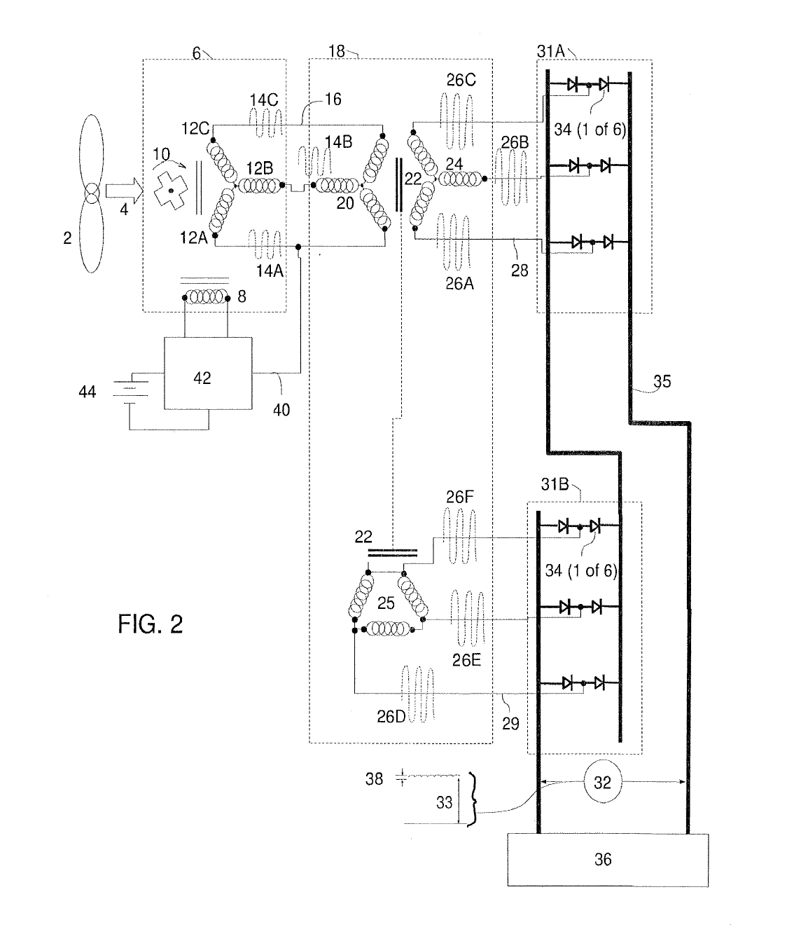

Another advantage of the present invention is apparent in an alternative embodiment detailed in FIG. 2 in which transformer 18 has two sets of electrically isolated secondary windings, a first set of high voltage secondary windings connected into a three-phase-wye 24 and a second set of high voltage secondary windings connected into a three-phase-delta 25. The high voltage outputs 26A, 26B, 26C from the wye secondary will be thirty electrical degrees out from the corresponding high-voltage outputs 26D, 26E, 26F of the delta wound secondary, which are connected to rectifier 30 by additional cable 29. In this embodiment rectifier 30 includes two separate hex phase rectifiers 31A and 31B, arranged as shown. Each rectifier 31A and 31B may use simple diode valve elements employing natural commutation, or may be selected to be active rectifiers using SCR or IGBT valve devices and hard switching as previously discussed. The output from each rectifier is connected by cable 35 in series with the other and load 36 to make the total electrical output 32 which is primarily DC 33. The effect of the thirty electrical degree phase difference in the rectification ripple of each output taken together with the series connection (instead of the normal parallel connection) is to dramatically reduce the net rectification ripple 38 in total output 32.

Furthermore, in the arrangement just described with respect to the embodiment of the invention represented in FIG. 2, the voltage ratios of the individual transformer's secondary windings and the voltage ratings of the individual rectifiers and rectifier valve elements (diodes) may be about one-half the values required in the embodiment of the invention represented by FIG. 1. Reducing the voltage ratings requirements on devices can often be a significant factor in improving reliability and reducing cost.

The system of the present invention may be arranged with multiple groups of the transformer secondary windings and rectifiers with the rectified output of the secondaries forming distinct subsets of DC power which can be added in series to form increasingly higher voltage DC output power. This can be done beneficially with or without the phase shifting arrangement of the wye-delta transformer interconnections as previously described and, in either case, brings the benefits of reducing the voltage rating requirements on the transformer windings and rectifier elements similar to those just cited.

Although the present invention has been described with respect to various embodiments, it should be realized that the invention is capable of a wide variety of further and other equivalent embodiments deemed to be within the scope and spirit of the inventions as defined by the appended claims.

What is claimed is:

1. A system for variable speed generation of controlled high-voltage direct current electrical power, the system comprising:
(a) a mechanical power source coupled to a shaft and arranged to provide rotary mechanical power;
(b) a field controlled alternator connected to the shaft, said alternator further comprising a magnetic structure including a rotor turned by said shaft and arranged to move relative to a fixed armature, said magnetic structure further comprising a set of electrical coils including one or more field coils arranged to establish a level of magnetic intensity within the magnetic structure under the influence of electrical field currents within said field coils, and also including multiple armature phase windings arranged so that relative motion between said rotor and said armature produces one or more sets of multiple distinct phases of phase-displaced alternating electrical output corresponding to said level of magnetic intensity and to the speed of said shaft;
(c) one or more transformer primary windings corresponding to said one or more sets of multiple distinct phases of phase-displaced alternating electrical output, wherein each of said primary windings is coupled by a transformer magnetic core structure suitable for transforming high frequency power to one or more corresponding high voltage secondary windings arranged to provide corresponding sets of multiple phases of high voltage alternating current suitable for rectification to high voltage direct current power;
(d) one or more multi-phase rectifiers suitable for rectifying said sets of multiple phases of high voltage alternating current into high voltage direct current power and configured to connect to a direct current load element;
(e) a controller provided with a reference indicating a desired level of electrical output and configured to adjust the level of said field currents in order to adjust said electrical output to the desired level of voltage and/or current;
(f) one or more feedback sensors coupled to said controller and arranged to sense the electrical output of said system; and
(g) an electrical power source for powering said controller and energizing said field coils.

2. The system as in claim 1 wherein said field controlled alternator is a brushless alternator.

3. The system as in claim 1 wherein one or more of said one or more transformer primary windings and said one or more high voltage secondary windings are arranged with multiple taps so that a voltage increase ratio can be adjusted to change the output voltage range of said to high voltage secondary windings to a desired high voltage range suitable for rectification to high voltage direct current power across a number of shaft speed ranges.

4. The system as in claim 1 wherein each of said sets of multiple distinct phases of phase displaced electrical output is comprised of three such phases arranged for three-phase operation, and wherein there are at least two sets of high voltage secondary windings corresponding to each set of distinct phases of alternating current output and arranged so that said high voltage secondary windings may be combined in various combinations of wye and/or delta interconnections in order to achieve at least one pair of sets of three phases of high voltage alternating current output, wherein the high voltage alternating current output second set within said pair is phase-shifted with respect to the high voltage alternating current output of the first set with said pair, and wherein such phase displaced sets of outputs are suitable for rectification to high voltage direct current power.

5. The system as in claim 4 wherein at least one first set of high voltage secondary windings is combined in a three-phase wye interconnection and rectified as a first subset of DC power and wherein a corresponding second set of high voltage secondary windings is combined in a three-phase-delta interconnection and rectified as a second subset of DC power and wherein the first and second subsets of DC power are combined in series to create a high voltage direct current output suitable for connection to a load.

6. The system as in claim 5 wherein there are multiple groups of high voltage secondary windings comprising pairs of sets thereof, wherein a first set of high voltage secondary windings is combined in a three-phase-wye interconnection and rectified as a first subset of DC power and a corresponding second set of high voltage secondary windings is combined in three-phase-delta interconnection and rectified as a second subset of DC power and wherein each pair of first and second subsets of DC power are combined in series to create a high voltage direct current output suitable for interconnection with the high voltage direct current output of the remaining groups of secondary windings to provide the high voltage direct current output for connection to the load.

7. The system as in claim 1 wherein there are multiple groups of sets of high voltage secondary windings corresponding to each set of multiple distinct phases of phase-displaced alternating electrical output and wherein each set of high voltage secondary windings is rectified into a distinct subset of DC power output and wherein each subset of DC power output is connected in series with other distinct subsets of DC power output to create a high voltage direct current output suitable for connection to a load.

8. The system as in claim 1 wherein said feedback sensors measure the output voltage and said controller is arranged to adjust the level of said field currents in order to adjust the output voltage to the desired level.

9. The system as in claim 1 wherein said feedback sensors measure the output current and said controller is arranged to adjust the level of said field currents in order to adjust the output current to the desired level.

10. The system as in claim 1 wherein said feedback sensors measure the output power and said controller is arranged to adjust the level of said field currents in order to adjust the output power to the desired level.

11. The system as in claim 1 wherein said electrical power source for powering said controller and energizing said field currents is derived from the output of the alternator.
